(19) United States
(12) Patent Application Publication
(10) Pub. No.: US 2019/0034996 A1
(43) Pub. Date: Jan. 31, 2019

(54) SHOE LAST SELECTION METHOD, BASED ON VIRTUAL FITTING SIMULATION AND CUSTOMER FEEDBACK

(71) Applicant: ELSE CORP S.r.I., Milano (IT)

(72) Inventor: Andrey Golub, Milano (IT)

(73) Assignee: ELSE CORP S.r.I., Milano (IT)

(21) Appl. No.: 15/980,793

(22) Filed: May 16, 2018

(30) Foreign Application Priority Data
Jul. 27, 2017 (IT) 102017000086288

(51) Int. Cl. G06Q 30/06; G06Q 30/02; G06T 19/00

(52) U.S. Cl. CPC G06Q 30/0631; G06T 19/00; G06Q 30/0282

(57) ABSTRACT

It is described a shoe-last selection method, comprising: providing a first set of digital data (SL_{S}) representing a first shoe-last of a first shoe associated with a foot of a customer; trying-on a shoe by the customer and sending to a processing module a customer feedback information (OV-ALL; CONF-ZNE) defining a customer perception on the fitting quality of said shoe; processing the first digital data (SL_{S}) on the basis of said customer feedback information (OV-ALL; CONF-ZNE) to alternatively generate: a second set of digital data (SL_{T}) representing a second shoe-last better fitting said foot than the first shoe-last and a confirmation that said first shoe-last fits said foot.

### BACKGROUND

### Technical Field

The present invention relates to a method for identification of shoe lasts and, preferably, also shoes, with criteria aiming an ideally fit and the most comfort on the fitting.

### CROSS REFERENCE TO RELATED APPLICATIONS

This is a utility patent application which claims the benefit of IT 102017000086288, filed on Jul. 27, 2017, the contents of which are hereby incorporated by reference in its entirety.

### Description of the Related Art

Fit is a crucial aspect in footwear comfort. Different methods configured to produce fit prediction models, e.g. based on statistical analysis, biometric analysis, 3D reconstructions from few photos etc. are known.

However, it is noticed that the known prediction techniques do not efficiently or not at all combine customer comfort on the real product, with marketing needs to define the collections, better covering potential clients as from the point of view of styling options, as well as for optimal fit.

### BRIEF SUMMARY

The Applicant has noticed that footwear design and manufacturing businesses need new technologies and approaches allowing better meet customer needs (e.g. style and fit preferences), designer proposals and manufacturer capabilities.

According to an aspect, the present description relates to a shoe-last selection method comprising:

providing a first set of digital data representing a first shoe-last of a first shoe associated with a foot of a customer;

trying-on a shoe by the customer and sending to a processing module a customer feedback information defining a customer perception on the fitting quality of said shoe;

processing the first digital data on the basis of said customer feedback information to alternatively generate: a second set of digital data representing a second shoe-last better fitting said foot than the first shoe-last and a confirmation that said first shoe-last fits said foot.

As an example, the method comprises a virtual fitting method for identifying an “ideal” shoe last for a particular customer, improved by a real customer feedback on the physical product. Particularly, with some additional reasoning base, also an ideal shoe can be identified from an existed collection or the identified ideal shoe is to be designed (for an individual customer or as part of a new collection).

### BRIEF DESCRIPTION OF THE DRAWINGS

Further characteristics and advantages will be more apparent from the following description of a preferred embodiment and of its alternatives given as a way of an example with reference to the enclosed drawings in which:

FIG. 1 shows an example of a footwear fitting system 100;

FIG. 2 schematically shows a simulation computing method, which incorporates individual customers' feedback on the physical try;

FIG. 3 illustrates an example of definition of shoe parts and shoe zones, for providing customer feedback on try on;

FIG. 4 shows the exemplary use of a user interface for feedback gathering and related processes.

### DETAILED DESCRIPTION OF EXAMPLES

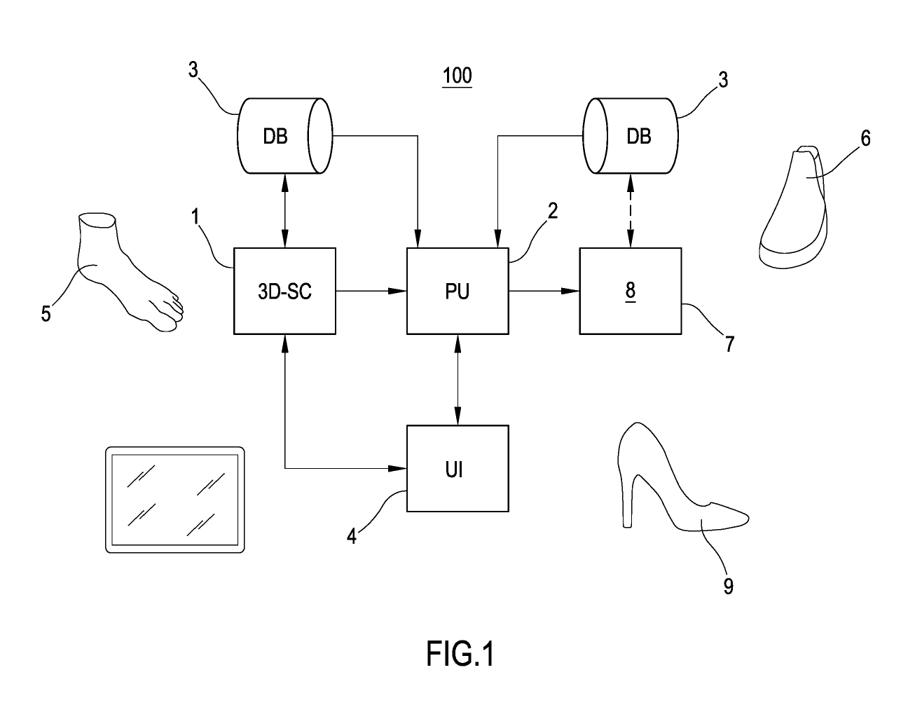

FIG. 1 schematically shows an example of a footwear fitting system 100 comprising an acquisition device 1 (3D-SC), at least one processing and control module 2 (PU), connected to at least one database 3 (DB) and at least one user interface 4 (UI).

The above devices/modules are interconnected each other, as an example, by a telematics net, such as the internet and/or they are part of a cloud or a combination of the two technologies. The connections between the above-indicated devices can be wireless, wired or a combination thereof.

The acquisition device 1 can be a 3D scanner configured to collect digital data on the shape (i.e. the external surface) of a customer foot 5. The processing and control module 2 comprises at least a computer machine in which software suitable to process digital data received from the acquisition device 1 is stored. As an example, the at least one processing and control module 2 can be a computer network including a plurality of interconnected computers where algorithms and software modules can be run.

Particularly, the processing and control module 2 can execute software modules 7 also comprising, preferably, one or more artificial intelligence software modules 8.

The database 3 can store digital data representing the external surfaces of customer's feet 5 and digital data representing the external surfaces of several pre-manufactured shoe-lasts 6. As known to the skilled person, a shoe-last is a solid 3D mold around which a shoe is made. A shoe-last is made in a material adapted to allow the manufacturing of the shoe and therefore it has suitable resistance to heat, compression and impact.

As shown by FIG. 1, the system 100 also includes at least one shoe 9, which is to be tried on by the customer 201. The database 3 stores digital representations DSL of shoe-lasts (including shoe-last 6 which is the shoe last used to manufacture the shoe 9).

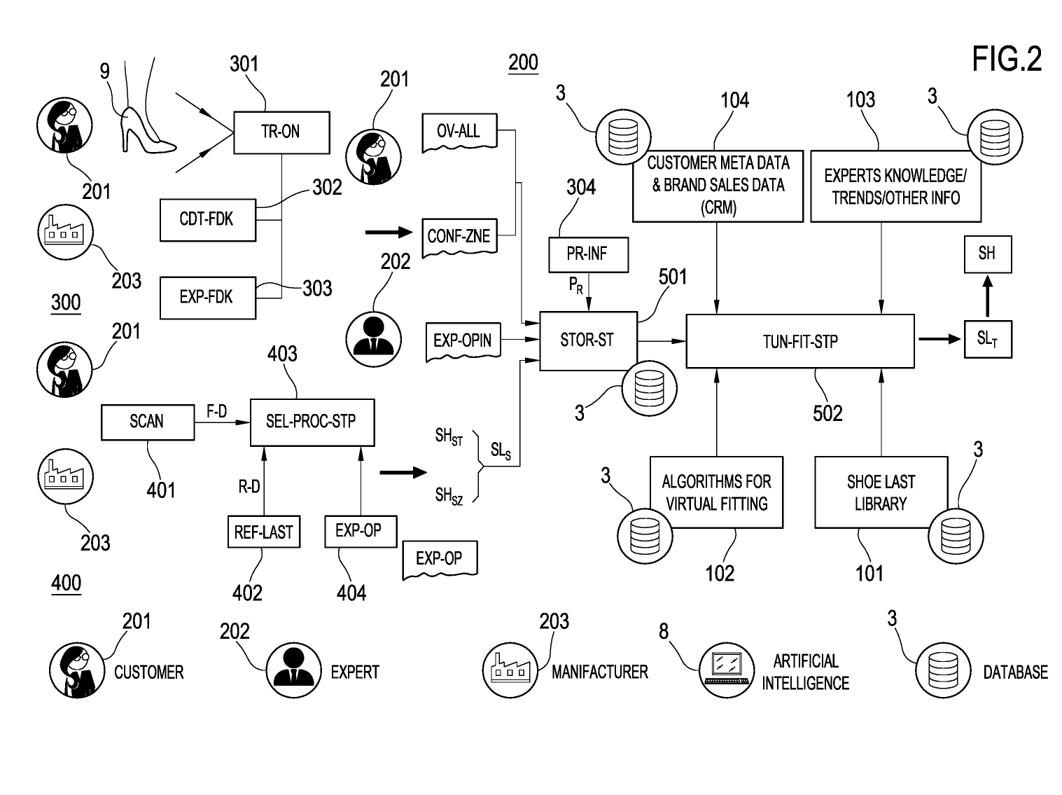

FIG. 2 shows schematically a footwear fitting method 200 comprising a real fitting method 300 and a simulation computing method 400. As schematically indicated in FIG. 2 the method 200 is implemented, as an example, by the following participants: a customer 201, an expert 202 and a manufacturer 203.

As will be clear from the following description of an example, the footwear fitting method 200 allows identifying a “best fit” shoe-last, based on a combination of virtual fitting simulation methods for shoe-last and foot scan comparative analysis, improved by a real customer feedback on the physical product, once and where applicable.

The present method is described with reference to a single shoe but it is easily extendable to a pair of shoes.

The simulation computing method 400 comprises a scanning step 401 (SCAN) in which the acquisition device 1 is employed to acquire current digital data F-D representing the shape of the foot 5 of the customer 201. The acquired current digital data F-D, which provide for a three-dimensional (3D) representation of the foot model, its extracted and analyzed measurements and metrics, and other related meta-data, are made available to the processing and control module 2.

In a retrieving step 402 (REF-LAST) the processing and control module 2 retrieves from the database 3 reference digital data R-D which define models of a plurality of shoe-lasts among the ones available for manufacturing shoes.

In a selection processing step 403 (SEL-PROC-STP), the current digital data F-D and the reference digital data R-F are compared each other to determine parameter/s SL_{S} of a selected shoe-last which will be considered in the subsequent steps. The selection processing step 403 can be performed by comparisons of 3D model of the scanned foot 5, along with its related measurements, metrics and another meta data, with the 3D models of the shoe-lasts, and its relevant measurements, metrics and meta data. In other words, the selection processing step 403 performs a virtual fitting of the selected shoe-last to the foot 5. Particularly, the selection processing step 403 can be configured to determine the best shoe-size SH_{SZ} (by identification of the ideally fitting shoe last) for that particular foot 5 of the customer 201 obtained by the scanner 1. In this case, the style of the shoe-last is pre-established and the selection processing step 403 performs calculations in order to determine the best shoe-size (which also determines the shoe-last size).

As it is known, there are a number of different shoe-size systems used worldwide. While all of them use a synthetic number to indicate the length of the shoe, they differ in exactly what they measure, what unit of measurement they use, and where the size 0 (or 1) is positioned. Some systems also indicate the shoe width, sometimes also as a number and the options like plumpness, but in many cases by one or more letters. Some regions use different shoe-size systems for different types of shoes (e.g. men's, women's, children's, sport, and safety shoes).

Alternatively, the selection processing step 403 can be configured to determine the best so-called shoe style SH_{ST} of a shoe-last for which the shoe-size has been pre-established, also by identifying an ideally fit shoe last, that refers to the matching criteria, defined as “best style”. The shoe style in this context is the model (the external shape) of the shoe and therefore is associated to the model of the shoe-last.

With reference to the selection processing step 403 it is observed that the shoe-last is a solid form, and the physical shoe is a more flexible object (based on the materials used eg. leather, neoprene, goretex . . . etc. . . . ), to accurately carry out said step 403 it is advantageous to understand how the 3D foot would fit the virtual shoe, rather than the solid shoe last.

With reference to the best shoe-size SH_{SZ}, the selection processing step 403 can be based on a metric comparison of the sizes of possible shoe-lasts with data (size of the feet) resulting from the scanning step 401.

With reference to the shoe style SH_{ST}, the selection processing step 403 can be configured to:
determine how the scanned bare feet measurements (when feet are not compressed in any way) correspond to the in-shoe-feet metrics;
approximately generate (as a 3D simulation) the inner space of the final shoe from the 3D last and valuable information, generated by virtual fitting algorithm.

The result of the selection processing step 403 (i.e. data SL_{S} defining a selected shoe-last and/or a shoe) are stored in the database 3 in a storing step 501 (STOR-ST).

The real fitting method 300 includes a test step 301 (TR-ON) in which the customer 201 tries on the shoe 9, which could be (ideally) a shoe in the costumer's standard size and (ideally) the closest sizes, smaller and bigger, to the customer's standard size, as an example, by the manufacturer 203.

The customer 201, in a customer's feedback step 302 (CST-FDK), provides a feedback specifying, as an example, if the shoe 9 fits in satisfying manner; i.e. the customer 201 provides a personal perception on the fitting quality of the shoe he/her has tried on. It is observed that the customer 201 has the opportunity to wear the real shoe 9 and walk around, so he can physically experience how shoe 9 feels when worn.

Particularly, the feedback provided by the customer 201 may be an overall perception OV-ALL that simply indicates if the shoe 9 provides for a good enough fit or not, based on customer's personal feeling about the product, his/her experience or believes about the product adaptation on the feet, with such kind of product or similar products.

The feedback provided by the customer 201 can include a comfort-zone based feedback CONF-ZNE which, in order to give a detailed analysis of why and where a product is a “perfect fit” or a “bad fit” for the customer 201, certain zones of shoe 9 are identified and a corresponding specific feedback is provided.

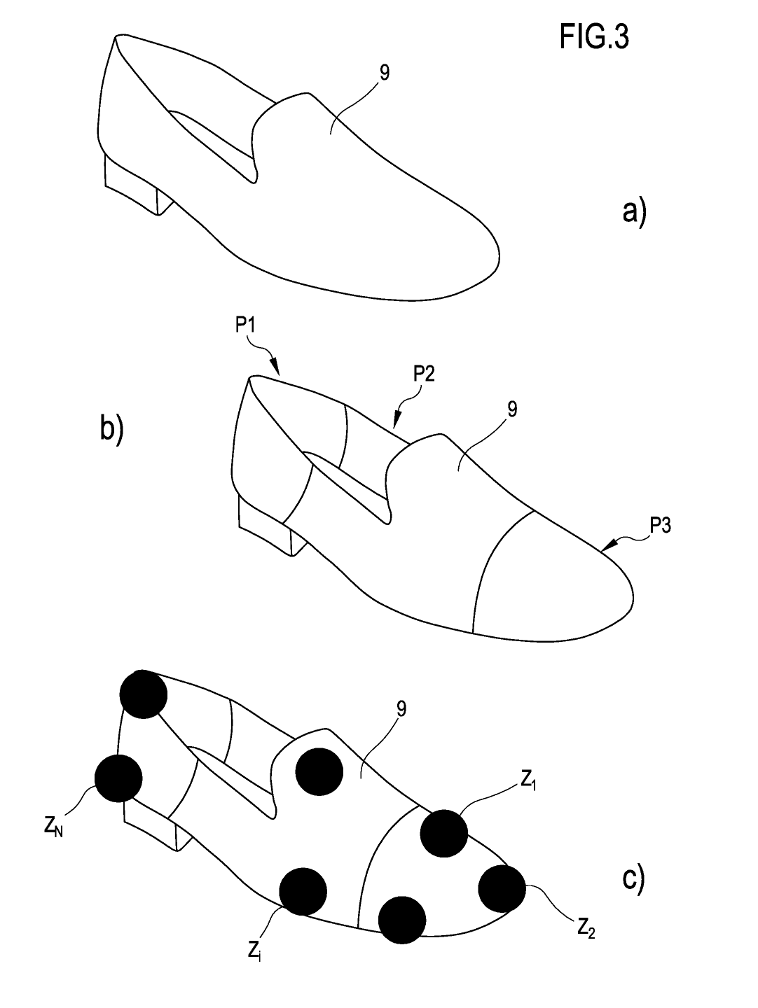

As it is shown in FIG. 3, a plurality of Product Parts P1-PN (comprising different zones Z1-ZM) can be defined for the shoe 9. Therefore, a feedback for each part P1-PN and its zones ZZ-ZN can be provided by the customer 201.

Preferably, in addition to customer's feedback on the real shoes step 302, an expert's opinion step 303 (EXP-FDK) can be provided on both, shoe last fitting related information and shoe fitting related information, (ideally) along with its virtual association (metrics and meta data) with the last, for a better setup of algorithms. In the expert's opinion step, the expert 202 (such as, an example a store assistant with specific knowledge of how the shoes should fit and how it might be adapted with time to a customer's feet) would give his/her opinions and analysis and recommend types of shoes that may fit better than others may. This could be by physically seeing and analyzing what fits the customer 201 or through any other experiments.

The expert 202 gives a rating EXP-OPIN related to the fit for the particular customer, which gets stored on the database 3. It would be similar to a stylist saying that an outfit “will be liked by a customer”—just based on their intuition and expertise, in respect of a concrete customer and a concrete or highly similar product, combining with general knowledge about shoe fitting.

The customer 201 can provide their feedback/opinion by means of a suitable user interface 4.

Moreover, in a product information step 304 (PR-INF) also product information PR are collected. The product information PR may include any information that can help in define a real shoe from the shoe-last data obtained from the selection processing step 403. Particularly, the product information represent a more precise approximation from the level of the simulation computing method 400 to the level of real shoe, made from particular materials (more or less elastic), cut and stitched/glued in particular way; all that helps predict the shoe adaptation logic to a foot, to be considered on top of the pure simulation and customer feedback incorporation.

It is observed that the product information PR can be also employed in the selection processing step 403 to define the shoe-last data also taking into account parameters of the shoe level, e.g. using Machine Learning techniques or Artificial Intelligence techniques. As an example, selected shoe-last data SLs can have different size or metric if the product will be a mule or a classic shoe. Particularly, the product information PR provided in the product information step 304 (PR-INF) refer to the shoe 9 that is tried on by the customer 201.

As symbolically indicated in FIG. 2, the customer's feedback (OV-ALL/CONF-ZNE), the rating EXP-OPIN and the product information PR can be collected into a database 3 in the storing step 501 (STOR-ST). The footwear fitting method 200 also includes a tuning fitting step 502 (TUN-FIT-STP) in which the digital data SL_{S} representing the shoe-last resulting from the selection processing step 403 can be modified to define another shoe-last (e.g. an optimal one) SL_{T} basing on the feedback provided by the customer 201 in the customer's feedback 302. As will be described later, the tuning fitting step 502 can also take into account the information (metrics, measurements, meta-data) related to the tried on shoe 9.

The tuning fitting step 502 takes, advantageously, into account also of the rating EXP-OPIN and/or the product information PR collected into the storing step 501.

As an example, the overall perception OV-ALL can be used in the tuning fitting step 502 to define the optimal shoe last SL_{T} driving to a shoe size different (greater or lower) from the one resulting from the selection processing step 403.

Particularly, also the comfort-zone based feedback CONF-ZNE can be used to define a better fitted (“ideally fitted”) shoe-last. As an example, if the comfort-zone based feedback CONF-ZNE indicates that the customer 201 feels that the shoe 9 is tight in the toe zone, a wider toe option is used in the customization of the shoe.

It is observed that the tuning fitting step 502 can lead to find an optimal shoe-last for that specific customer 2 among the ones already available or to define a new custom shoe last (usually referred by the industry as “made to measure”).

The optimal existing last or the new custom shoe last to be newly produced (new or by a direct modification of an existed last) can be used to retrieve from a store or to manufacture another shoe that can be purchased (as from a stock) or ordered (to be produced on demand) by the customer 201.

The tuning fitting step 502 allows, particularly, defining a shoe SH that, as an example, can be sold to the customer so matching his/her comfort requirements.

The tuning fitting step 502, in consideration of the feedback provided by the customer 201 (OV-ALL/CONF-ZNE), may also confirm that the shoe-last data resulting from the selection processing step 403 is satisfying for the customer 201.

Particularly, it is observed that tuning fitting step 502 operates employing the same algorithm used in the selection processing step 403. Reference is now made to the overall perception OV-ALL that can be provided by the customer as feedback. As an example, the user may adopt a scale to evaluate the overall perception including at least two evaluation attributes: comfortable or uncomfortable. Preferably, a scale comprising more than two evaluation attributes may be used. As an example, the following five-level scale is employed:

1. very comfortable (ideal fit)

2. enough comfortable (acceptable fit)

3. uncomfortable but (bad fit, needs more reasoning)

4. not comfortable (wrong fit)

5. very uncomfortable (very bad fit)

As regard the comfort-zone based feedback CONF-ZNE the following main parts of a shoe can be defined: P1=Back; P2=Upper; P3=Toe (FIG. 3). Moreover, each Part P1-PN may include one or more zones Z1-ZM.

The comfort-zone based feedback CONF-ZNE may include a multi-level symmetric scale, such as an example:

1) too tight;

2) OK

3) too wide.

As an example, a file level-symmetric scale can be employed:

1) too;

2) tight

3) OK

4) wide

5) too wide.

The zones Z1-ZM can be defined considering that each type of shoe may have different criteria to be considered for the definition of its parts/zones, based on its structure and parts integration methods. Below are indicated some particular considerations on specific shoe aspects that can be useful to defines the Zones:
Shoe last: Standard last designs are defined mainly by heel height and shoe style. These lasts have an acceptable fit, which has been market tried and tested, and remain invariant for years. This means that all commercially available shoes offer practically the same fit. A number of brands, however, have developed wide sizes in order to increase the number of users who perceive a positive fit sensation when wearing these wider-fit shoes. In view of this, three categories of last fit can be defined: wide, standard and tight.
Toe cup: The main style-related changes that affect last design are mostly related to toe shape. This is a relevant factor as it affects the perception of fit in the toe area. Accordingly, three types of toe shapes can be defined: squared, rounded and pointed.
Upper flexibility: The upper rigidity of a shoe is the main factor that influences how a shoe adapts to foot shape. Correspondingly, three levels of rigidity can be defined: low, medium and high. Level of rigidity is assigned accordingly to a data base of characterized materials and takes into account kind and quality of material and thickness of the upper.
Fastener adjustments: The level of adjustment provided by the shoe fastener is also an important variable in shoe fit. A fastener with a high adjustment level accommodates a greater variety of foot shapes and gives the sensation of a more comfortable fit in the instep area. Four levels of fastener adjustment can be defined: low (elastic fastener), medium (strap and belt), high (laces), and an additional level for bumps without an upper covering the instep area.
Sole: Sole design could be an important variable in considering dynamic fit as high sole rigidity may reduce the capacity of a shoe to adapt to foot shape. Three levels of sole rigidity that took into account the combination between the material and the geometry of the sole could be defined.

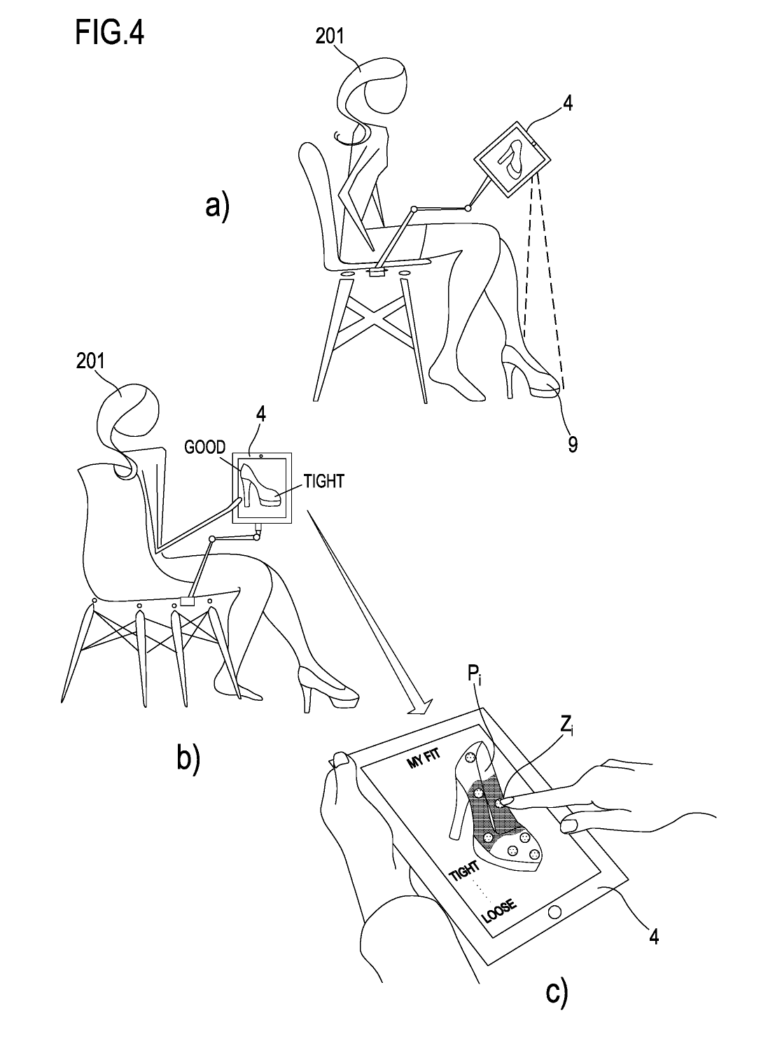

FIG. 4 refers to an example of the customer's feedback step 302 wherein the customer 201 employs as user interface 4 a tablet where a specific application (i.e. a feedback collection program) has been downloaded.

The customer 201 physically tries on a pair of shoes 9 (FIG. 4a). The shoe 9 is recognized by a dedicated User Interface application running in the user interface 4. The dedicated User Interface application running on the user interface 4 shows and interacts with the customer in some way, identifies the shoe 9 she/he is trying on, with all the parts P1-PN and zones Z1-ZM indicated on it.

The customer 201 inputs her/his feedback based on each (ideally) or some (most critical) of the zones on the shoe 9 (FIG. 4b). This is done for each foot—left and right. The customer (FIG. 4c) may select the zone Zi that she/he wants to give feedback on, and then gives that chosen zone a rating (e.g. good/tight) based on the different possible criteria. Parts of the shoe 9 and the zones Zi on them are indicated.

The above described feedback collecting process and its related User Interface and Applications could be executed for example in store—directly by the customer or with help of a sales assistant, at home directly by the customer or someone on its behalf, online via the brand's or retailer's or any other distribution related player's interface.

With reference to the retrieving step 402 (FIG. 2), it is observed that the reference digital data R-D stored in the database 3 are, particularly, initial data that have been collected in advance, preferably, from a brand collection. As an example, the reference digital data R-D correspond to physical shoes from the collections that have been tried on by a set of people and their general feedback has been collected to find the best fitting foot for each shoe. The results of the experiments are objective and based on general feedback that is evident from the fitting e.g. too loose, too tight, good fit. Also in this case, two types of objective feedback can be adopted: General Overall Fit, Comfort Zone Related.

The simulation computing method 400 may also include a further expert's opinion step 404 (EXP-STP) in which another opinion (EXP-OP) provided by an expert or provided by an informatics tool based on expert methods (symbolically represented by the expert 202) is made available for the selection processing step 403. It is clarified that the expert 202 of the simulation computing method 400 is an entity which normally is different from the expert 202 involved in the footwear fitting method 200.

Particularly, the expert action on the selection processing step 403 is not related to a specific customer and can be based on a Basic Research (CAD Based General Analysis of Standard Metrics etc.) or Detailed Research (CAD Supported Manual Analysis of Comfort Zones based general data on the zones from initial setup).

The Basic Research can be carried out by the expert or automated procedures using CAD or statistical analysis or big data analytics or machine learning or similar tools, to make conclusions about the shoe-lasts fitting properties towards 3D foot models, to be obtained from scans.

The CAD helps the experts make their tuning related decisions by:
i. Visually showing what the fitting looks like, and providing some hints. The expert still has to make their own decisions but the CAD serves as a visual tool to assist them in the process.
ii. The CAD takes into account physical properties of materials such as resistance, elasticity, rigidity etc. which helps the expert to “predict” the fitting more accurately.

The CAD Based Analysis (manual or semi-automated or completely automated) of the shoe last and the general comfort zones. The ‘problem’ zones related to the ‘comfort zones’ Z1-ZM can be seen through the comparison of the last and 3D foot model, statistical analysis and another kind of semi-automated analysis. These data can be used by the expert to tune the algorithm of the selection processing step 403.

It is observed that the tuning fitting step 502 may be performed also using additional sources of data that can be constantly updated.

Particularly, a shoe-last library 101 can be stored in one or more of the databases 3. The shoe-last library 101 a database of shoe lasts across brands, manufacturers etc. Preferably, the shoe lasts are all represented as parametric 3D models. Each shoe last in the library has as much information as possible collected about it, such as:
all measurements and dimensions,
related brands,
similar shoe lasts from different brands or same brand,
part identification (based on x,y,z axis)
zone identifications (based on x,y,z axis)
recommended feet types.

The tuning fitting step 502 may also employ one or more algorithms for virtual fitting 102 additional or alternative to the one of the selection processing step 403. As an example, the algorithm for virtual fitting 102 may be one of the following algorithm types: Biometric Algorithms; Statistical Analysis Algorithms; Comparison by Direct Measurement, Comparison of Micro-surfaces/Cut-sets.

The Comparison by Direct Measurement is based on the comparison of a last with a foot scan extracted from the 3D foot scan or from a biometric database (as that of IBV), or in any other way—related or not related to the 3D models themselves.

The Comparison of Micro-surfaces/Cut-sets, which are already 3D oriented, is based on a comparison of e normalized data obtained by a scan of the foot and the selected shoe last, and a subsequent analysis of how each micro-surface, and each cut-set, based on some characteristics, are different.

The Comparison by 3D value of the crossed volumes is based on a comparison of the volumes of the foot scan and the volume of the shoe last by the determination of the corresponding volume crossing.

Moreover, the tuning fitting step 502 may also take into account additional information 103 (EXPERT KNOWLEDGE/TRENDS/OTHER INFO) such as:
Manufacturer's advice for suitable foot types for each shoe;
Best product types for each foot type—based on parts & zones;
Trends;
Seasonal Data;
Product information: analogous to the ones described with reference to the product information step 304.

The tuning fitting step 502 can also take advantages from meta data 104 (CUSTOMER META DATA & BRAND SALES DATA (CRM)) including, as an example:
Customer's measurements;
Customer's Past Sales Data;
Customer's Preference Data;
Other Customer's Sales Data;
Other Customer's Preference Data;
Seasonal info;

The above described system 100 and method 200 show several advantages over the prior art.

The above described system 100 and method 200 allow optimizing the main product sales and distribution flow, by helping customers purchasing their “ideal” products from the collections already available on the market (available for the purchase in a local store, from a regional or global stock, via e-commerce or even made to order).

Moreover, with reference to shoe producing/marketing companies, the above described system 100 and method 200 allow better (predictive analysis based) product designing: from the direct and precise feedback from the market the companies know what their customers want/need and don't want and so, they can design better products, optimized for the known customer segments. Moreover, the described system and method provide an opportunity for new manufacturing scenarios: subscription based, individual direct sales/direct suggestions for ideal products etc.

With reference to the customers, further advantages can be envisaged.

The feedback supplied by the customer 201 for each purchase is stored and analyzed in a database 3 where the individual style and size preferences are learned, so each following purchase is more precise. Moreover, the customer can train their personal profile for future use, by trying on as many pairs as they like (in store or at a factory, already purchased or just available for a physical try on), even without or before buying any of them—all their feedback would get stored.

As the individual fitting algorithm can be very precise, for the future purchases scenario it shall be possible to produce on demand and to buy without trying for both categories of product orders—“best fit” (optimal shoe last based) or “made to measure” (by generating or patching to get an individual shoe last, to be used for the requested pair of shoes production).

It could be possible to supply feedback on an existing shoe owned by the customer, which wasn't bought with help of algorithms and in a virtual way, but if it's possible with some “universal database” of shoe lasts, or intelligent algorithms, able to identify approximately and to find a closest corresponding last, even if from different company/manufactured from the one the customer has a shoe, this would unlock the scenario “I have a good/bad shoe, and I want/do not want a new one”, with feed-back over existed products.

It is also possible to integrate the above method with the production of a customized shoe-last to manufacture a shoe basing on a “fitting profile” associated to the customer and also considering his/her style preferences.

1. A shoe-last selection method, comprising:
providing a first set of digital data (SL_{S}) representing a first shoe-last of a first shoe associated with a foot of a customer;
trying-on a shoe by the customer and sending to a processing module a customer feedback information (OV-ALL; CONF-ZNE) defining a customer perception on the fitting quality of said shoe;
processing the first digital data (SL_{S}) on the basis of said customer feedback information (OV-ALL; CONF-ZNE) to alternatively generate: a second set of digital data (SL_{T}) representing a second shoe-last better fitting said foot than the first shoe-last and a confirmation that said first shoe-last fits said foot.

2. The method of claim 1, wherein the second shoe-last is one on the following: an already available shoe last, a new custom shoe last to be produced, a modified pre-existing shoe-last.

3. The method of claim 2, further comprising: associating a further shoe to the second shoe last and providing the further shoe to the customer.

4. The method of claim 1, wherein said customer feedback information includes an indication relating to an overall perception (OV-ALL) indicating if the shoe provides for a good fit or not.

5. The method of claim 1, wherein said customer feedback information includes comfort information (CONF-ZNE) on fitting quality of pre-established portions (Pi, Zi) of the shoe.

6. The method of claim 1, further comprising:
sending to the processing module an expert feedback information (EXP-FDK) defining an expert opinion on a fitting quality of a further shoe for said customer; wherein said processing of the first digital data (SL_{S}) also takes into account said expert feedback information.

7. The method of claim 2, further including:
providing the customer with a user interface configured to send said customer feedback information (OV-ALL; CONF-ZNE) toward said processing module.

8. The method of claim 1, processing the first digital data (SL_{S}) on the basis of said customer feedback information (OV-ALL; CONF-ZNE) to generate a second set of digital data (SL_{T}) representing a second shoe-last.

9. The method of claim 1, wherein providing a first set of digital data (SL_{S}) representing a first shoe-last comprises:
acquiring foot digital data (F-D) representing the shape of a foot (5) of the customer;
retrieving from a database reference digital data (R-D) which define models of a plurality of shoe-lasts;
comparing the foot digital data (F-D) with the reference digital data (R-D) to define selected digital data (SL_{S}) representing a selected shoe-last.

10. The method of claim 7, wherein comparing the foot digital data (F-D) with the reference digital data (R-D) comprises:
pre-defining one of the following information: size of the shoe, model of the shoe;
determining a selected shoe model if a fixed shoe size has been pre-defined and determining a selected shoe size if a fixed shoe model has been predefined.

11. The method of claim 1, wherein processing the first digital data (SL_{S}) on the basis of said customer feedback information comprises one of the following:
generating the second set of digital data (SL_{T}) representing the second shoe-last having a corresponding modified shoe size different from a shoe size of the first shoe-last;
generating the second set of digital data (SL_{T}) representing the second shoe-last having a corresponding modified shoe model different from a shoe model of the first shoe-last.

12. The method of claim 1, wherein processing the first digital data (SL_{S}) on the basis of said customer feedback information (OV-ALL; CONF-ZNE) is also based on product information (PR) defining a real shoe from shoe-last data.
